(19) United States
(12) Patent Application Publication
(10) Pub. No.: US 2026/0342783 A1
(43) Pub. Date: Oct. 29, 2026

(54) DEVICE ONBOARDING IN DISTRIBUTED SYSTEMS USING REMOTELY HOSTED DATA

(71) Applicant: Dell Products L.P., Round Rock, TX (US)

(72) Inventors: NYI NYI THWIN, Singapore (SG); GOVIND PULIKODE MUKUNDAN, Singapore (SG); BRADLEY K. GOODMAN, Nashua, NH (US); ASHISH MISHRA, Singapore (SG)

(21) Appl. No.: 19/190,136

(22) Filed: Apr. 25, 2025

(51) Int. Cl. H04L 9/40; G06F 16/23

(52) U.S. Cl. CPC H04L 63/0823; G06F 16/2365; H04L 63/0884

(57) ABSTRACT

Methods and systems for managing endpoint devices are provided. The endpoint devices may be managed by onboarding them to a deployment. To onboard the endpoint devices, ownership vouchers and a certificate chain may be used to cryptographically verify to which entities authority over the endpoint devices have been delegated. The ownership vouchers may also include a uniform resource locator (URL) that may be used by an orchestrator to obtain data for the endpoint device from a remote entity that hosts the data. The URL may be added as part of a certificate of the certification chain. The data may also be cryptographically verified and subsequently used to verify integrity of the endpoint devices for onboarding to the deployment.

### FIELD

Embodiments disclosed herein relate generally to device management. More particularly, embodiments disclosed herein relate to systems and methods to manage onboarding of devices.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components, and hosted entities such applications, may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with an embodiment.

FIGS. 1B-1I show diagrams illustrating aspects of operation of the system of FIG. 1A in accordance with an embodiment.

FIGS. 2A-2B show interaction diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing authority in a distributed system. To manage authority, endpoint devices may be onboarded.

During onboarding, authority over the endpoint devices may be established. To establish the authority, ownership vouchers, proxy certificates, and/or other data structures may be presented to the endpoint devices. The endpoint devices may utilize these data structures to identify the entities that have authority over the endpoint devices.

The ownership vouchers may delegate authority over the endpoint devices by including public keys. The public keys may be used to demonstrate that an entity alleged to have authority of the endpoint device has access to corresponding private keys.

Entities such as orchestrators may be tasked with onboarding the endpoint devices. To enable orchestrators to demonstrate that they have authority over the endpoint devices, the proxy certificates may extend the chains of certificates/delegations included in the ownership voucher. The extended chains may designate keys controlled by the orchestrators that have authority over the endpoint devices. Thus, the endpoint devices may validate that the orchestrators have been delegated authority over the endpoint device from other entities to which authority is explicitly delegated in the ownership vouchers.

To onboard the endpoint devices, an orchestrator may perform an integrity verification process for the endpoint devices. To do so, the orchestrator may utilize enablement data hosted by (e.g., embedded on) the ownership vouchers. Because an ownership voucher may have a storage limitation, onboarding of an endpoint device using the enablement data may be negatively impacted when the enablement data exceeds the storage limitation. Furthermore, updates to the enablement data may not be captured when the ownership vouchers are transferred between owners of the endpoint devices.

To facilitate onboarding of the endpoint devices using the enablement data, the orchestrator may obtain the enablement data using a uniform resource locator (URL) indicated on the ownership voucher. The URL may point to a network device that hosts signed data that includes at least the enablement data. The orchestrator may verify an integrity of the signed data and subsequently perform the integrity verification process for the endpoint devices using the enablement data.

Accordingly, embodiments disclosed herein may address, among others, the technical problem of verifying integrity of endpoint devices during onboarding. The disclosed embodiments may do so by obtaining enablement data using a URL from an ownership voucher for the endpoint devices.

In an embodiment, a method for managing endpoint devices of a distributed system is provided. The method may include: (i) identifying, by an orchestrator, a new endpoint device of the endpoint devices requesting to join a deployment managed by the orchestrator; (ii) obtaining, by the orchestrator and using a uniform resource locator (URL) from an ownership voucher for the new endpoint device, a portion of data from a remote entity; (iii) attempting, by the orchestrator and using at least a certificate chain from the ownership voucher, to verify integrity and trustworthiness of the portion of the data; (iv) in a first instance of the attempting where the integrity and trustworthiness of the portion of the data is verified: (a) performing, by the orchestrator, an integrity verification process for the new endpoint device; and (b) in an instance of the performing where integrity of the new endpoint device is successfully verified: (i) onboarding, by the orchestrator and using the ownership voucher, the new endpoint device to the deployment.

The orchestrator may also use a proxy certificate to attempt to verify the integrity and the trustworthiness of the portion of the data, the proxy certificate delegating authority over the new endpoint device from an owner indicated by the ownership voucher to the orchestrator.

The portion of data may include enablement data for the new endpoint device, the enablement data indicating characteristics of the new endpoint device that are expected of the new endpoint device.

The enablement data may include at least one selected from a list consisting of: (i) a device image for the new endpoint device; (ii) a type of the new endpoint device; and (iii) licensing information for the new endpoint device.

The device image may include a list of hardware components of the new endpoint device.

Performing the integrity verification process for the new endpoint device may include: (i) obtaining, by the orchestrator, information regarding hardware components of the new endpoint device; (ii) comparing, by the orchestrator, the information to the list of hardware components; (iii) in an instance of the comparing where the information substantially matches the list of the hardware components: (a) concluding that the integrity of the new endpoint device is successfully verified. Substantially matching may mean that at least a predetermined fraction (e.g., 80%, 90%, 95%, etc.) of the contents of the information matches content of the list.

The information may substantially match matches the list of the hardware components when matching criteria is met, the matching criteria indicating a minimum level of matching between the information and the list of the hardware components.

The URL may specify a network endpoint, and the URL being a part of a certificate of the certificate chain.

The network endpoint may include reachability information for a network device maintained by a manufacturer of the new endpoint device or an intermediate owner of the new endpoint device.

Onboarding the new endpoint device may include issuing, by the orchestrator, at least one work order for performance by the new endpoint device, the at least one work order being cryptographically verifiable by the new endpoint device using, at least, the certificate chain.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the method when the computer instructions are executed by the processor.

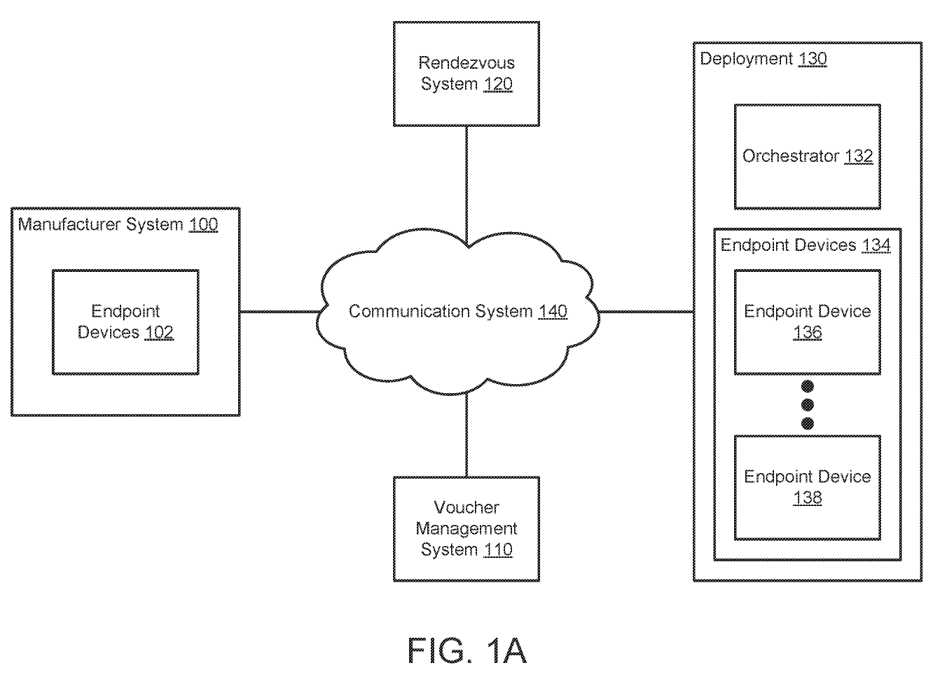

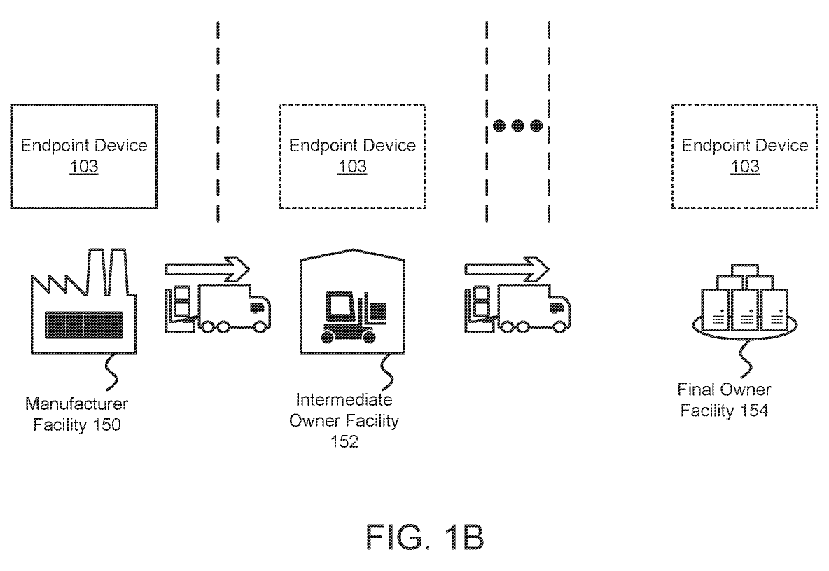

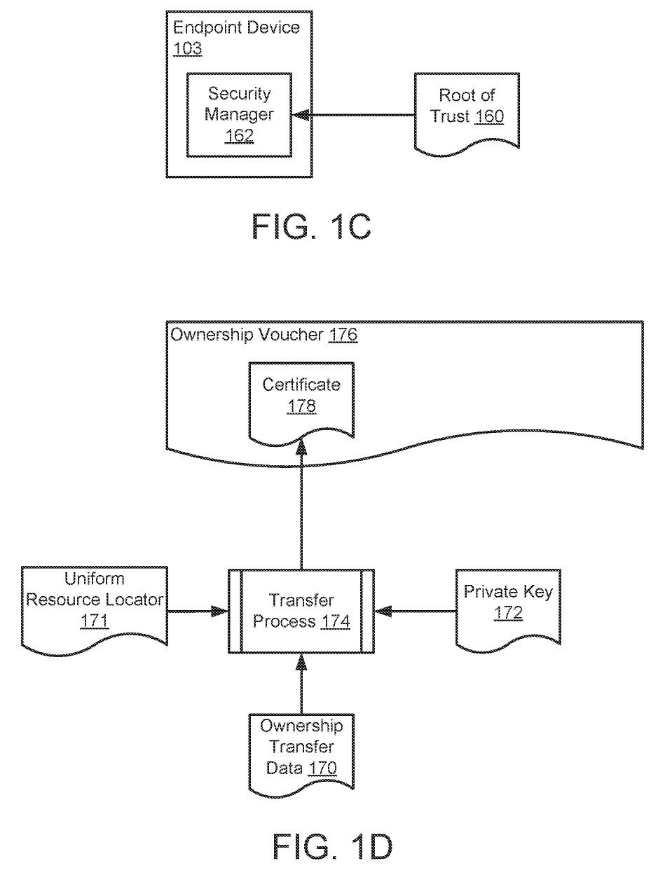

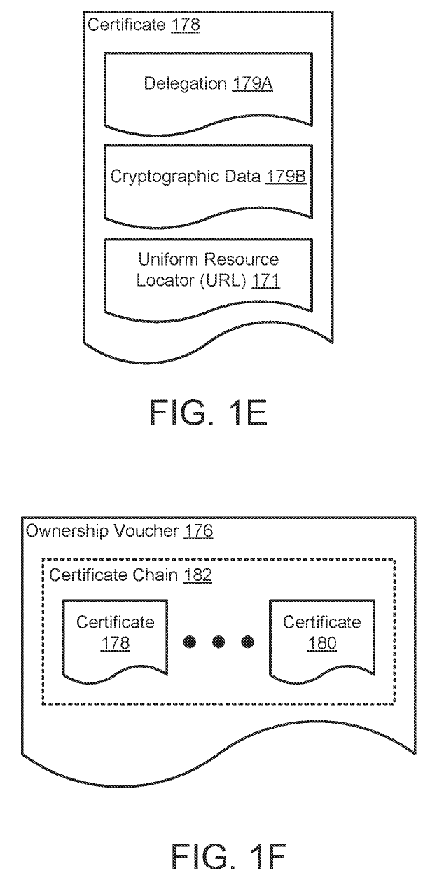

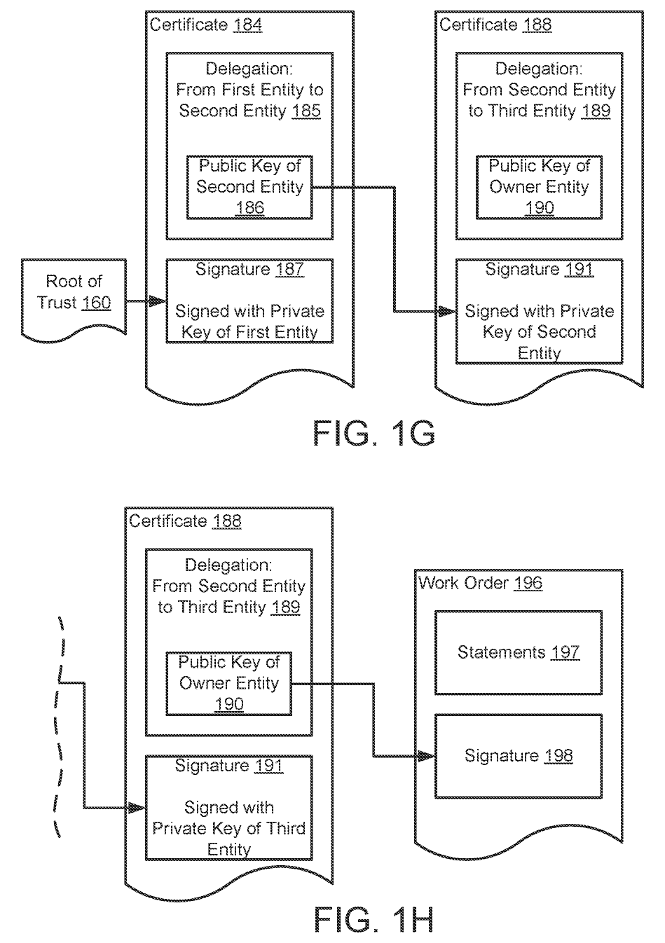

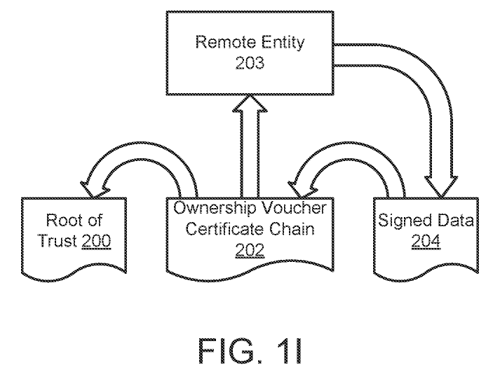

Turning to FIG. 1A, a block diagram illustrating a system in accordance with an embodiment is shown. The system shown in FIG. 1A may provide computer-implemented services. The computer implemented services may include any type and quantity of computer implemented services. For example, the computer implemented services may include data storage services, instant messaging services, database services, and/or any other type of service that may be implemented with a computing device.

To provide the computer implemented services, any number of endpoint devices may be deployed to a deployment. The endpoint devices may cooperatively provide the computer implemented services.

To manage the endpoint devices to provide the computer implemented services, authority over the endpoint devices may need to be established. In other words, the endpoint devices must be able to ascertain that they are under the authority of a particular entity. Based on this authority, the entity may, for example, issue work orders and/or other types of instructions to manage the operation of the endpoint devices to provide desired computer implemented services.

To facilitate ascertaining of the authority over them, the endpoint devices may utilize secrets. The secrets may allow the endpoint devices to cryptographically verify delegations of authority over the endpoint devices from a root of trust (e.g., a trusted key of a manufacturer) to another entity (e.g., an owner).

Over time the resources requirements for providing computer implemented services may change and/or endpoint devices may need to be replaced. For example, additional services may be desired to be provided, different types of services may be desired to be provided, etc. In another example, an endpoint device that contributed to the computer implemented services may cease to operate thereby reducing the quantity of resources available to provide the computer implemented services. To satisfy the resource requirements based on these changes to existing systems, additional endpoint devices may be onboarded and thereby contribute to the resources available to provide the computer implemented services.

However, onboarding an endpoint device may require access to particular types of cryptographic information. If this cryptographic is not available, then the endpoint devices may not be able to be onboarded.

Further, to facilitate management of large numbers of endpoint devices, multiple management entities such as orchestrators may be utilized. To successfully onboard endpoint devices, the orchestrator that onboards each endpoint device may need to have access to the particular cryptographic information (e.g., the endpoint devices may only recognize the authority of entities that can demonstrate access to the cryptographic information).

To onboard the endpoint devices, an orchestrator may perform an integrity verification process for the endpoint devices requesting to onboard. To do so, the orchestrator may utilize enablement data hosted by (e.g., embedded on) ownership vouchers. An ownership voucher may be a cryptographically verifiable data structure usable to establish which entities have authority over the endpoint devices. Because an ownership voucher may have a storage limitation, onboarding of an endpoint device using the enablement data may be negatively impacted when the enablement data exceeds the storage limitation. Furthermore, updates to the enablement data may not be captured when the ownership vouchers are transferred between owners.

In general, embodiments disclosed herein may provide methods, systems, and/or devices for managing endpoint devices to improve their likelihood of being able to verify integrity of the endpoint devices thereby allowing them to contribute to desired computer implemented services. To improve the likelihood, embodiments disclosed herein may provide a framework for onboarding endpoint devices in a manner that allow for the endpoint devices to be verified using enablement data hosted by a remote entity.

The framework may include processes that may allow an orchestrator to obtain the enablement data using a uniform resource locator (URL) indicated on an ownership voucher. The URL may point to a network device that hosts signed data that includes at least the enablement data. The orchestrator may verify an integrity of the signed data (e.g., using a corresponding public key for the signed data from the ownership voucher) and subsequently perform the integrity verification process for the endpoint devices using the enablement data.

To provide the above noted functionality, the system of FIG. 1A may include manufacturer system 100, voucher management system 110, rendezvous system 120, deployment 130, and communication system 140. Each of these components is discussed below.

Manufacturer system 100 may be a system used by a manufacturer of endpoint devices 102. Manufacturer system 100 may include, for example, factories, assembly plants, distribution facilities, and/or other types of facilities for creating endpoint devices 102. Endpoint devices 102 may be data processing systems which may be usable to provide various computer implemented services.

When manufactured, manufacturer system 100 may put endpoint devices 102 in condition for subsequent onboarding to various deployments (e.g., 130) and/or other environments (e.g., data centers, edge systems, etc.) in which endpoint devices may be positioned to provide desired computer implemented services.

To place endpoint devices 102 in condition for subsequent onboarding, manufacturer system 100 may (i) establish a root of trust for each endpoint device, (ii) record various information regarding the endpoint devices (e.g., hardware/software loadout, identifiers of various components positioned therein, etc.), (iii) host the various information on a remote entity reachable via a network endpoint (e.g., a URL), and (iv) install various pieces of software, establish various configuration settings, update various hardware components, and/or perform other actions so that only entities to which authority over the endpoint devices has been delegated from the root of trust are able to control and/or otherwise use the endpoint device. Refer to FIG. 1C for additional details regarding establishing a root of trust for the endpoint device.

Once constructed, endpoint devices 102 may be sold directly to end users and/or placed into the stream of commerce (e.g., sold to resellers, etc.) and through which endpoint devices 102 eventually reach end users. Refer to FIG. 1B for additional details regarding how endpoint devices may reach end users (e.g., individuals, organizations, etc.).

As ownership over the endpoint devices changes, information regarding the changes in ownership and/or authority may be recorded in an ownership voucher. The ownership voucher may allow an end user to establish authority over the endpoint device such that the endpoint device will be usable by the end user.

Voucher management system 110 may document and manage information regarding changes in ownership and authority over endpoint devices 102. To do so, voucher management system 110 may generate ownership vouchers. An ownership voucher may be a cryptographically verifiable data structure usable to establish which entities have authority over endpoint devices 102.

For example, an ownership voucher may include certificate chains that documents the changes in ownership and authority over endpoint devices 102. Each certificate may be signed using various keys. The keys used to sign (e.g., private keys) and keys included in (e.g., public keys) in ownership vouchers may enable endpoint devices to ascertain whether to trust various data structures, such as work orders which may be signed. Refer to FIGS. 1D-1I for additional information regarding ownership vouchers.

When one of endpoint devices 102 is obtained by an end user, the end user may add the endpoint devices to a collection such as deployment 130. When so added, an orchestrator (e.g., 132) or other entity may utilize a corresponding ownership voucher from voucher management system 110 to establish authority over the endpoint device. In this manner, any number of endpoint devices (e.g., 134) may be onboarded and brought under the control of a control plane which may include any number of orchestrators (e.g., 132). Different endpoint devices (e.g., 136, 138) may be onboarded at different points in time and/or for different purposes.

The ownership voucher provided by voucher management system 110 may delegate authority over the endpoint device to the end user by establishing a public key of a public private key pair maintained by the end user as having been delegated authority over the endpoint device. To issue verifiable work orders or other types of instructions to the endpoint device, the work order may need to be signed by the private key of the public private key pair. However, for security and/or other purposes, orchestrator 132 may not have access to the private key.

To enable orchestrator 132 to establish authority over an endpoint device without having access to the private key, orchestrator 132 may utilize a proxy certificate. The proxy certificate may be a cryptographically verifiable certificate that further delegates authority from the end user to another entity such as orchestrator 132.

In other words, the proxy certificate may establish an additional delegation (beyond the delegations in the ownership voucher) by adding an additional certificate (or multiple) to the certificate chain included in an ownership voucher. The combination of the ownership voucher and proxy certificate may allow the endpoint device to establish a verifiable chain of delegations of authority from the root of trust to an entity designated by the owner of the endpoint device.

Furthermore, orchestrator 132 may obtain information from a remote entity using a URL hosted by the ownership voucher. For example, orchestrator 132 may access the URL, verify a trustworthiness of data hosted at the URL using a public key, retrieve the data in an instance the data is determined to be trustworthy, use the data to facilitate onboarding of corresponding endpoint devices, and/or perform any other actions. For example, consider a scenario in which information (e.g., a list of hardware components) regarding an endpoint device is updated. The information may be updated on the remote entity and signed using a new private key. Orchestrator 132 may subsequently verify the trustworthiness of the updated information using a new corresponding public key.

When one of endpoint devices 102 initially powers on after manufacturing, the endpoint device may reach out to rendezvous system 120. Rendezvous system 120 may be a system that directs endpoint devices to entities such as orchestrator 132 that will onboard the endpoint devices.

To do so, the entities such as orchestrator 132 may provide rendezvous system 120 with information usable to authenticate that orchestrator 132 will manage the endpoint devices. For example, orchestrator 132 may provide information from ownership vouchers, proxy certificates, and/or other sources to rendezvous system 120. Once verified, rendezvous system 120 may redirect endpoint devices to the corresponding entities when the endpoint devices reach out to rendezvous system 120 after being powered on.

Once onboarded, endpoint devices 134 may perform various operations to complete onboarding. The operations may include any number and type of operation (e.g., configuration operations, security operations, software installation operations, account establishment operations, etc.), and the operations may be directed by orchestrator 132. For example, an integrity of a new endpoint device may be verified by orchestrator 132 using device enablement data obtained from the URL, work orders may be issued for performance by the new endpoint device, and/or any other processes may be performed to facilitate onboarding of the new endpoint device. Once onboarded, the new endpoint device may begin to contribute to computer implemented services by deployment 130.

When providing their functionality, any of manufacturer system 100, endpoint devices 102, voucher management system 110, rendezvous system 120, deployment 130, orchestrator 132, and/or endpoint devices 134 may perform all, or a portion, of the processes, interactions, and methods illustrated in FIGS. 1B-3.

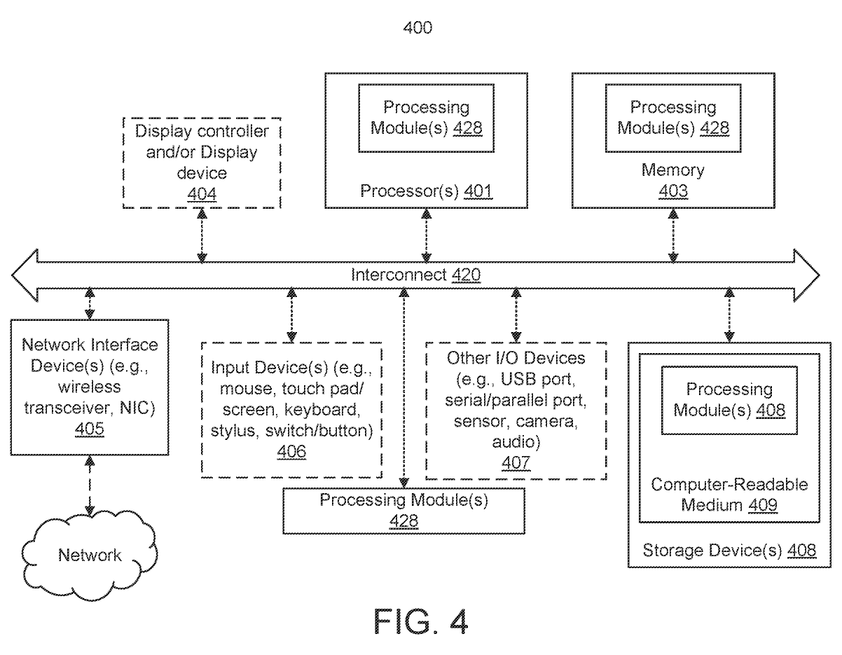

Any of manufacturer system 100, endpoint devices 102, voucher management system 110, rendezvous system 120, deployment 130, orchestrator 132, and/or endpoint devices 134 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), and edge device, an embedded system, local controllers, an edge node, and/or any other type of data processing device or system. For additional details regarding computing devices, refer to FIG. 4.

Any of the components illustrated in FIG. 1A may be operably connected to each other (and/or components not illustrated) with communication system 140. Communication system 140 may facilitate communications between the components of FIG. 1A. In an embodiment, communication system 140 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1A as including a limited number of specific components, a system in accordance with an embodiment may include fewer, additional, and/or different components than those illustrated therein.

As discussed above, endpoint devices (e.g., 102) may traverse through a stream of commerce between when the endpoint devices are manufactured and when the endpoint devices reach a final owner. Turning to FIG. 1B, diagram of an example path through a stream of commerce in accordance with an embodiment is shown.

In FIG. 1B, vertical dashed lines indicate different geographic locations in which various facilities may be positioned. Representations of such facilities (e.g., 150-154) may be positioned below the pages. Representations of movement of endpoint devices between these facilities is illustrated using truck shaped images. Some instances of the graphical representation of endpoint device 103 are illustrated using dashed outlining to indicate that endpoint device 103 may only be present at one of the facilities at any point in time, and the instance of the graphical representation of endpoint device 103 drawn in solid outlining indicates where endpoint device 103 is located in the example shown in FIG. 1B.

The stream of commerce may begin, for example, at manufacturer facility 150. Manufacturer facility 150 may be a facility operated by a manufacturer of endpoint devices. During manufacturing, the manufacturer may establish a root of trust for an endpoint device (e.g., 103). Refer to FIG. 1C for additional details regarding establishing the root of trust for endpoint device 103. The root of trust may be used by endpoint device 103 to discern which entities have authority over it, which entities to trust, and/or for other purposes. The initial root of trust may indicate that the manufacturer is the owner of and has authority over endpoint device 103.

Once the root of trust is established, endpoint device 103 may be sold and resold to various intermediate owners. These intermediate owners may operate various intermediate owner facilities (e.g., 152), such as warehouses, distribution centers, sales rooms, etc. When sold, endpoint device 103 may be shipped to these various facilities.

Finally, once purchased from an intermediate owner, a final owner may operate a final owner facility (e.g., 154), such as a data center, edge deployment, and/or other type of computer deployment to which endpoint device 103 may be onboarded. To facilitate onboarding, voucher management system 110 may collect and add information regarding changes in ownership of endpoint device 103 to an ownership voucher. At least a portion of the information may be added to the ownership voucher via a uniform resource locator (URL) for subsequent retrieval by orchestrator 132. Orchestrator 132 may use the ownership voucher and/or a proxy certificate to establish authority over endpoint device 103.

Turning to FIG. 1C, a diagram of an example process for establishing a root of trust in endpoint device 103 in accordance with an embodiment is shown. To establish a root of trust, when endpoint device 103 is manufactured, root of trust 160 may be installed in endpoint device 103.

Root of trust 160 may be a public key of a public private key pair controlled by the manufacturer of endpoint device 103. The public private key pair may be established using any process.

To install root of trust 160, root of trust 160 may be stored in endpoint device 103. The storage location and security precautions taken with respect to storing root of trust 160 may vary depending on the architecture of endpoint device 103.

For example, endpoint device 103 may host or include a security manager (e.g., 162). Security manager 162 may be implemented using a discrete hardware component, or may be a software component. Security manager 162 may enforce various security policies on endpoint device 103. For example, the security policies may require that endpoint device 103 validate authority over it back to root of trust 160 before complying with any instructions from other entities that allege to have authority over endpoint device 103.

To validate entities having authority over endpoint device 103, endpoint device 103 may utilize ownership vouchers and/or proxy certificates.

Turning to FIG. 1D, a diagram of an example process for generating ownership voucher 176 in accordance with an embodiment is shown. To generate ownership voucher 176, information regarding changes in ownership and authority over an endpoint device may be added. The information may take the form of a cryptographically verifiable certificate (e.g., 178). Refer to FIG. 1E for additional information regarding certificate 178.

To add a certificate to ownership voucher 176, transfer process 174 may be performed. During transfer process 174, ownership transfer data 170, uniform resource locator 171, and private key 172 may be obtained. Ownership transfer data 170 may document a change in ownership and/or authority over an endpoint device. For example, when an endpoint device is sold, a public key of a public private key pair controlled by the purchaser may be added to ownership transfer data 170, along with other types of information regarding the transfer. This public key may be usable to verify signed work orders or other signed data structures from the new owner (e.g., the new owner may be able to use the corresponding private key for signing). The information in ownership transfer data 170 may be treated as a delegation statement, which an endpoint device may parse to identify entities having authority over it.

Uniform resource locator 171 may be a network endpoint for a remote entity (e.g., a network device) maintained by a manufacturer of the endpoint device or an intermediate owner of the endpoint device. Uniform resource locator 171 may be used to access at least a portion of data usable to onboard the endpoint device following transfer process 174. Uniform resource locator 171 may be implemented, for example, by obtaining a URL from a new owner of the endpoint device, embedding the URL into a field of certificate 178, and/or via any other processes. Because the uniform resource locator 171 may be static, the portion of data hosted on the remote entity may be updated (e.g., following transfer process 174), signed using a private key, and made available for access using uniform resource locator 171.

Private key 172 may be a private key of a public private key pair controlled by an entity that has authority over an endpoint device at the time authority over the endpoint device changes (e.g., via sale or other mechanism). In a scenario in which the manufacturer is the seller, the private key corresponding to the root of trust may be private key 172. Similarly, in a scenario in which an intermediate owner is the seller, private key 172 may be the private corresponding to the public key included in the delegation statement in ownership voucher 176 that establishes the intermediate owner has the owner of the endpoint device. In other words, to establish a delegation of authority, the entity that has authority over the endpoint device as defined by the certificates of ownership voucher 176 may need to sign the ownership transfer data 170 to further delegate ownership and authority over the endpoint device. By doing so, a chain of delegations that are cryptographically verifiable back to the root of trust may be established. Refer to FIGS. 1F-1H for additional details regarding establishing chains of delegations.

Any number of certificates may be added to ownership voucher 176 thereby enabling certificate chains that establish chains of delegation from the root of trust for an endpoint device. Ownership voucher 176 may, as discussed above, be used during onboarding.

Turning to FIG. 1E, a diagram of an example certificate 178 in accordance with an embodiment is shown. Certificate 178 may include delegation 179A and cryptographic data 179B.

Delegation 179A may include information documenting a delegation of authority/ownership over an endpoint device. For example, delegation 179A may include a public key, and indicate what is delegated to the entity that has control over the public private key pair of which the public key is a member. The extent of what is delegated may be specified at a macro level (e.g., ownership) or a micro level (e.g., limited authority).

As previously discussed in FIG. 1D, uniform resource locator 171 may be include a network endpoint that may host at least a portion of data relevant to an endpoint device for joining a deployment. By using uniform resource locator 171 to direct the entity to obtain the portion of data from a remote entity, a likelihood that the portion of data may exceed a storage limitation of certificate 178 may be reduced.

Cryptographic data 179B may include signature usable to verify the integrity of delegation 179A and ascertain whether delegation 179A is valid. Cryptographic data 179B may also be used to verify an integrity and/or trustworthiness of the portion of data obtained from uniform resource locator 171.

To determine whether certificate 178 includes a valid delegation, an endpoint device may attempt to establish a chain of delegations back to the root of trust.

Turning to FIG. 1F, a diagram of an example certificate chain 182 of ownership voucher 176 in accordance with an embodiment is shown. Certificate chain 182 may be a series of certificates that can be sequentially validated back to the root of trust. To sequentially validate the certificate back to the root of trust, the first certificate (e.g., 178) in the chain may attempt to be validated using the root of trust (e.g., a public key). Thus, the first certificate in the chain may only be validated if the private key (e.g., controlled by the manufacturer) corresponding to the root of trust was used to sign certificate 178. Other certificates in the chain may be similarly validated by using the public key from the delegation statement of the previous certificate to check the signature in the next certificate in the chain. Certificate chain 182 may include any number of certificates (e.g., 178-180) that can be sequentially verified back to the root of trust. Refer to FIGS. 1G-1H for additional information regarding establishing valid certificate chains.

Turning to FIG. 1G, a diagram of an example process for validating a portion of a certificate chain of an ownership voucher in accordance with an embodiment is shown. In FIG. 1G, two certificates (e.g., 184, 188) from a certificate chain are shown.

As seen, certificate 184 may include delegation 185 which includes a public key (e.g., 186) of a second entity. The delegation statement may indicate that a first entity is delegating authority to the second entity.

Certificate 184 may include signature 187. Signature 187 may be generated using a private key controlled by the first entity that delegated authority to the second entity. In this example, the private key may correspond to root of trust 160 (e.g., may be a private corresponding to the public key installed when an endpoint device is manufactured).

To establish a certificate chain, signature 187 may be checked using root of trust 160. If verified as having been signed using the private key corresponding to the root of trust, then certificate 184 may be treated as being valid.

Like certificate 184, certificate 188 may include delegation 189 which includes a public key (e.g., 190) of a third entity, and in this example the owner. The delegation statement of delegation 189 may indicate that the second entity is delegating authority to the third entity (i.e., the owner).

Certificate 188 may include signature 191. Signature 191 may be generated using a private key controlled by the second entity that delegated authority to the third entity. In this example, the private key may correspond to the public key (e.g., 186) of the second entity which may be included in delegation 185.

To extend the certificate chain, signature 191 may be checked using public key of second entity 186. If verified as having been signed using the private key corresponding to public key of second entity 186, then certificate 188 may be treated as being valid.

Once the chain is established, the delegations (e.g., 185, 189) in the chain may be parsed to identify keys to which authority has been delegated from root of trust 160. These public key may then be used to decide whether various work orders are valid, which entities have authority of an endpoint device, and/or for other purposes.

For example, during onboarding, an endpoint device may evaluate whether to perform various work orders using the keys to which authority has been delegated.

Turning to FIG. 1H, a diagram of an example process for validating a work order in accordance with an embodiment is shown. In FIG. 1H, only a portion of the certificates (e.g., 184, 188) shown in FIG. 1G are shown for clarity.

When a work order (e.g., 196) is received by an endpoint device, the endpoint device may evaluate whether the entity issuing the work order has authority over the endpoint device. To do so, the endpoint device may parse the certificates to identify the public keys to which authority over the endpoint device has been delegated.

The endpoint device may then, using the keys, check a signature (e.g., 198) included in the work order. If the signature can be verified as having been generated using the private key corresponding to one of the public keys to which authority over the endpoint device has been delegated, then the endpoint device may treat work order 196 as having been issued by an entity with authority over it. For example, signature 198 may be checked using public key of owner entity 190, in this example.

The endpoint device may then, for example, process various statements 197 included in work order 196, and take action based on those statements. These statements may include instructions that change the manner of operation of the endpoint device to, for example, comply with security requirements of a new owner, and/or perform other actions.

However, in some cases, orchestrators or other entities may lack access to the private key to which public key of owner entity 190 and/or other public keys in the certificate chains delegate authority over the endpoint device. Thus, the orchestrators may lack the ability to generate work orders that may be validated by the endpoint devices using information from ownership vouchers.

For example, turning to FIG. 1I which shows a diagram in accordance with an embodiment, signed data 204 such as a work order may be validated if public keys included in ownership voucher certificate chains (e.g., 202) correspond to private keys to which the work order issuing entity has access. In this example, ownership voucher certificate chain 202 may be used to establish delegations of authority from root of trust 200 for an endpoint device to the keys used to sign signed data 204.

Signed data 204 may further include, for example, device enablement data regarding the endpoint device hosted by remote entity 203. Remote entity 203 may include any number and/or type of entity adapted to host information regarding endpoint devices. For example, remote entity 203 may include a network device, a remote hosting server, and/or any other type of hosting service provider that may be managed by a manufacturer of the endpoint device and/or an intermediate owner of the endpoint device. The device enablement data may similarly be signed (e.g., by remote entity 203 using a private key) and validated using a corresponding public key included in ownership voucher certification chain 202.

However, if other signed data is signed using keys that cannot be validated as having authority delegated and/or having remotely hosted data with integrity using ownership voucher certificate chain 202, then the endpoint device may treat the other signed data as not being trustworthy.

To enable other signed data to be validated, embodiments disclosed herein may utilize proxy certificates (not shown). The proxy certificates may be used to extend the chains of certificates and delegation statements from those included in ownership voucher certificate chain.

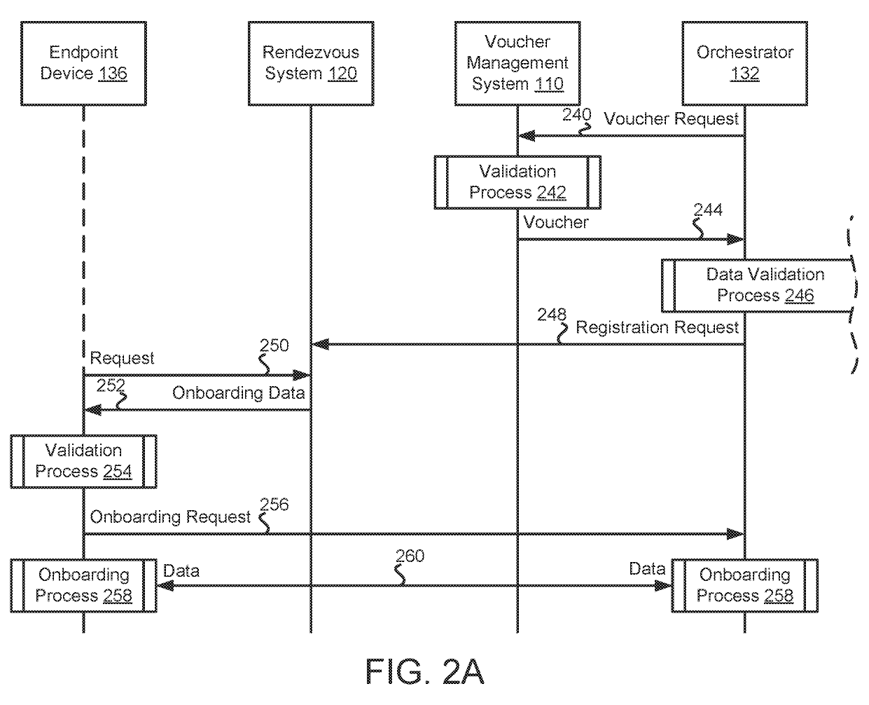

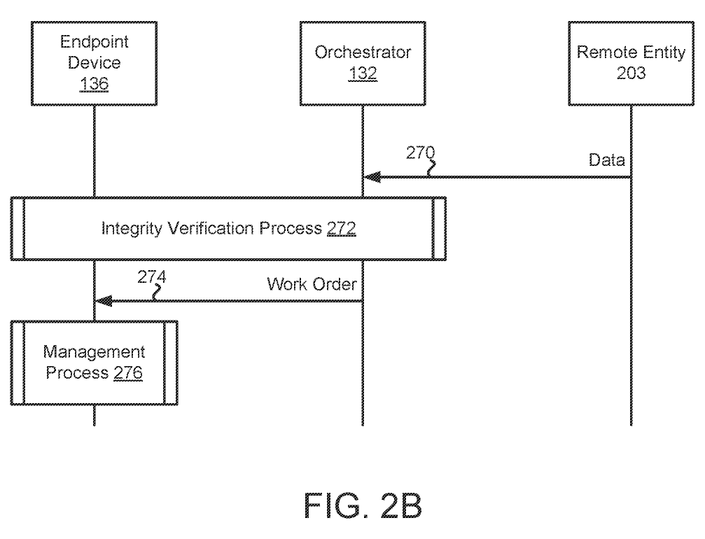

To further clarify embodiments disclosed herein, interactions diagrams in accordance with an embodiment are shown in FIGS. 2A-2B. These interactions diagrams may illustrate how data may be obtained and used within the system of FIGS. 1A-1I.

In the interaction diagrams, processes performed by and interactions between components of a system in accordance with an embodiment are shown. In the diagrams, components of the system are illustrated using a first set of shapes (e.g., 110, 120, 132, 136, etc.), located towards the top of each figure. Lines descend from these shapes. Some descending lines are drawn in dashing to indicate that the device is not operating during corresponding periods of time, while other lines are drawn solid to indicate that the devices are operating during the corresponding period of time. For example, in FIG. 2A, endpoint device 136 may not be operating until interaction 250.

Processes performed by the components of the system are illustrated using a second set of shapes (e.g., 242, 246, etc.) superimposed over these lines. Interactions (e.g., communication, data transmissions, etc.) between the components of the system are illustrated using a third set of shapes (e.g., 240, 244, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 240 may occur prior to the interaction labeled as 244. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate processes and interactions that may occur during onboarding of an endpoint device.

To onboard endpoint device 136, orchestrator 132 may, at interaction 240, send a voucher request to voucher management system 110. The voucher request may be a request for an ownership voucher for an endpoint device (e.g., 136). In the example interactions shown in FIG. 2A, an entity may have purchased endpoint device 136 thereby causing voucher management system 110 to add information to the ownership voucher for endpoint device 136 that establishes chains of certificates/delegations from the root of trust to the owner.

When received, voucher management system 110 may attempt to validate the voucher request by performing validation process 242. During validation process, credentials and/or other information from orchestrator 132 may be evaluated to ascertain whether an ownership voucher should be provided. Presuming that the validation process is successful, at interaction 244, voucher management system 110 may send an ownership voucher to orchestrator 132.

Once obtained, orchestrator 132 may verify an integrity of a portion of data defined by the ownership voucher by performing data validation process 246. During data validation process 246, orchestrator 132 may access a URL specified by the ownership voucher and validate the portion of data hosted by a remote entity at the URL. To access the URL, orchestrator 132 may attempt to establish a network connection to the remote entity using reachability information indicated by the URL. To validate the portion of the data, orchestrator 132 may use a public key (e.g., included in certificate chains of the ownership voucher and/or from a proxy certificate) to validate a signature of the portion of data hosted at the URL.

At interaction 248, orchestrator 132 may send a registration request to rendezvous system 120. The registration request may be a request to have rendezvous system 120 redirect endpoint device 136 to orchestrator 132. The registration request may include information usable by rendezvous system 120 to verify that orchestrator 132 should have authority over endpoint device 136.

Once endpoint device 136 reaches a destination location (e.g., a data center, edge deployment, etc.), endpoint device 136 may be powered on and may, at interaction 250, send a request to rendezvous system 120 regarding which entity to contact as part of an onboarding procedure.

Presuming the rendezvous system 120 registered orchestrator 132 based on the registration request, rendezvous system may, at interaction 252, provide onboarding data to endpoint device 136. The onboarding data may include, for example, various validation information and re-direct information (e.g., network address) for orchestrator 132.

Once obtained, endpoint device 136 may perform validation process 254. During validation process 254, endpoint device 136 may attempt to validate the onboarding data. If successfully validated, endpoint device 136 may, at interaction 256, generate and send an onboarding request to orchestrator 132. The onboarding request may request, for example, cryptographic data such as ownership vouchers and proxy certificates. The request may initiate a cooperatively performed onboarding process 258 by endpoint device 136 and orchestrator 132.

During onboarding process 258, orchestrator 132 may provide endpoint device 136 with the ownership voucher, a proxy certificate, and/or other information to enable endpoint device 136 to ascertain whether orchestrator 132 has authority over endpoint device 136. To do so, endpoint device 136 may, as discussed above, attempt to validate certificate chains and delegation statements to establish a chain of delegation of authority from the root of trust to orchestrator 132 (e.g., the delegation statements may identify a particular public key for which orchestrator 132 controls a corresponding private key). Endpoint device 136 may issue various challenges (e.g., signing challenges) to orchestrator 132, and endpoint device 136 may test the signed responses to the challenges using the particular public key. If the signed responses can be validated using the public key, then endpoint device 136 may conclude that orchestrator 132 has authority over it.

If successfully validated as having authority over it, endpoint device 136 may continue to participate in the onboarding by, for example, evaluating the trustworthiness of signed work orders issued by orchestrator 132, and complying with any signed work orders that can be validated as having been signed with the private key corresponding to the particular public key.

The aforementioned work orders may cause endpoint device 136 to, for example, modify its configuration, install/remove software, enable/disable various hardware components, establish accounts for end users, and/or perform other operations as directed by orchestrator 132. The aforementioned operations may place endpoint device 136 in an operating state specified by the owner of endpoint device 136.

Turning to FIG. 2B, a second interaction diagram in accordance with an embodiment is shown. The second interaction diagram may illustrate processes and interactions that may occur during onboarding of an endpoint device using remotely hosted data.

At interaction 270, data may be provided by remote entity 203 to orchestrator 132. As previously discussed in FIG. 2A, the data may be accessed by orchestrator 132 using a URL included in an ownership voucher obtained for the endpoint device. The data may be verified (e.g., using cryptographic information of the ownership voucher), downloaded from remote entity 203, stored (e.g., at least temporarily) by orchestrator 132 for subsequent use in onboarding the endpoint device, and/or any other processes may be performed to obtain the data. The data may include, for example, device enablement data for the endpoint device (e.g., a device image, a type of device, licensing information, etc.).

Once obtained, an integrity of endpoint device 136 may be verified by performing integrity verification process 272. During integrity verification process 272, orchestrator 132 may obtain information regarding hardware components of endpoint device 136 and compare the information to the device enablement data. For example, orchestrator 132 may obtain the information (e.g., configuration, list of hardware and/or software components, etc.) by communicating with endpoint device 136 using a management interface, communication protocols, and/or any other processes. The obtained information may subsequently be compared to the device enablement data to identify whether the information meets criteria relevant to the device enablement data. For example, the device enablement data may specify a list of hardware components that are expected to be hosted by endpoint device 136 (e.g., as configured by a manufacturer of endpoint device 136). By performing integrity verification process 272, orchestrator 132 may onboard endpoint device 136 in a more secured and/or otherwise desired manner.

At interaction 274, a work order may be provided to endpoint device 136 by orchestrator 132. The work order may be provided, for example, by issuing instructions for endpoint device 136 to perform to facilitate onboarding of endpoint device 136. As previously discussed in FIG. 2A, endpoint device 136 may validate that orchestrator 132 has authority over it with respect to issuing the work order.

To complete the onboarding to the deployment, management process 276 may be performed. During management process 276, operation of endpoint device 136 may be updated based at least in part on the work order. For example, the operation of endpoint device 136 may be updated to modify its configuration, install/remove software, enable/disable various hardware components, establish accounts for end users, and/or perform other operations as directed by orchestrator 132 based on the work order. The aforementioned operations may place endpoint device 136 in an operating state specified by the owner of endpoint device 136 using, at least in part, data stored on a remote entity.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, the processes and interactions shown in FIGS. 2A-2B may be used to facilitate endpoint device onboarding using data hosted by a remote entity and accessed using a uniform resource location included in an ownership voucher for the endpoint device. By doing so, a likelihood that desired data (e.g., a desired quantity of data, updated data, etc.) is available may be improved.

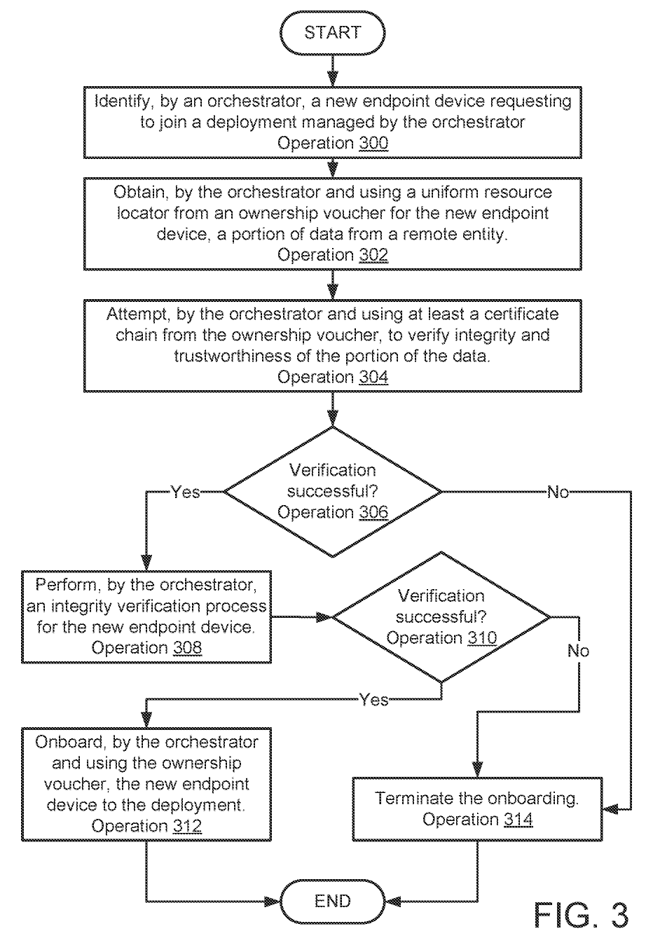

As discussed above, the components of FIG. 1 may perform various methods to onboarding endpoint devices. FIG. 3 illustrates a method that may be performed by the components of the system of FIGS. 1A-1I. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method for performing an onboarding in accordance with an embodiment is shown. The method may be performed by any of the components of the system shown in FIG. 1A.

At operation 300, it may be identified that a new endpoint device is requesting to join a deployment managed by an orchestrator. The new endpoint device may be identified by: (i) powering on the endpoint device, (ii) contacting a rendezvous system defined for the deployment, (iii) being directed to the orchestrator or other device, and/or via any other processes.

At operation 302, a portion of data may be obtained from a remote entity by the orchestrator. The portion of data may be obtained by: (i) obtaining an ownership voucher for the endpoint device, (ii) reading a uniform resource locator (URL) embedded on a portion (e.g., a field) of the ownership voucher, (iii) accessing the URL (e.g., establishing a network connection with the remote entity directed by the URL), (iv) downloading the portion of data from the URL, and/or performing any other actions.

At operation 304, an attempt may be made to verify integrity and trustworthiness of the portion of the data. Because the portion of the data may be signed using a key possessed by an owner of the remote entity and/or that manages the portion of the data accessible via the URL, the orchestrator may attempt to verify the integrity and trustworthiness of the portion of the data using at least one public key from the ownership voucher. The at least one public key may be identified by establishing a certificate chain from a root of trust (e.g., established by a manufacturer of the endpoint device) to various public key included in delegation statements in the certificates in the certificate chain.

At operation 306, it may be determined whether the integrity and trustworthiness of the portion of the data is verified (e.g., whether the attempt of operation 304 is successful). If the verification of operation 304 is successful, then the method may proceed to operation 308. Otherwise, the method may proceed to operation 314.

At operation 308, an integrity verification process may be performed by the orchestrator for the new endpoint device. The integrity verification process may be performed by: (i) obtaining information regarding hardware components of the new endpoint device, (ii) comparing the information to characteristics expected of the new endpoint device and defined by the portion of the data obtained at operation 302, (iii) identifying whether the information meets criteria indicating a minimum level of matching between the information and the expected characteristics, and/or performing any other actions.

At operation 310, it may be determined whether the integrity of the portion of the endpoint device is verified (e.g., whether the verification of operation 308 is successful). If the verification of the new endpoint device at operation 308 is successful, then the method may proceed to operation 312. Otherwise, the method may proceed to operation 314.

At operation 312, the new endpoint device may be onboarded to the deployment by the orchestrator and using the ownership voucher. The onboarding may be completed by obtaining signed instructions from the orchestrator, attempting to verify the signed instructions using a public key (e.g., from a proxy certificate), and performing any work orders that can be verified. For example, the signatures of the work orders may be checked using the public key and a signature verification algorithm.

The instructions may include, for example, replacing an existing root of trust maintained by the endpoint device (e.g., with the public key from the proxy certificate), modifying a configuration of the endpoint device, installing/removing software, and/or performing other actions that may place the endpoint device in condition to provide desired computer implemented services that meet the expectations of an owner (e.g., the orchestrator may include various policies that define the specific changes to the operation of the endpoint device that are to be made during onboarding).

The method may end following operation 312.

Returning to operation 306, the method may proceed to operation 314 following operation 306 when the verification of the integrity and trustworthiness of the portion of the data is not successful. The method may also proceed to operation 314 following operation 310 when the new endpoint device is not successfully verified via the integrity verification process.

At operation 314, the onboarding may be terminated. The onboarding may be terminated by the orchestrator prevent the endpoint device from joining the deployment, providing a notification to an owner of the deployment regarding the termination of the onboarding for the endpoint device, and/or performing any other actions.

The method may end following operation 314.

Thus, using the method shown in FIG. 3, embodiments disclosed herein may facilitate onboarding of a new endpoint device to a deployment using data accessed via a URL implemented on an ownership voucher for the endpoint device. By doing so, the endpoint device may be placed in a desired operating state specified for the deployment and based on the data.

Any of the components illustrated in FIGS. 1A-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows^{®} operating system from Microsoft^{®}, Mac OS^{®}/iOS^{®} from Apple, Android^{®} from Google^{®}, Linux^{®}, Unix^{®}, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing operation of endpoint devices of a distributed system, the method comprising:
identifying, by an orchestrator, a new endpoint device of the endpoint devices requesting to join a deployment managed by the orchestrator;
obtaining, by the orchestrator and using a uniform resource locator (URL) from an ownership voucher for the new endpoint device, a portion of data from a remote entity;
attempting, by the orchestrator and using at least a certificate chain from the ownership voucher, to verify integrity and trustworthiness of the portion of the data;
in a first instance of the attempting where the integrity and trustworthiness of the portion of the data is verified:
performing, by the orchestrator, an integrity verification process for the new endpoint device; and
in an instance of the performing where integrity of the new endpoint device is successfully verified:
onboarding, by the orchestrator and using the ownership voucher, the new endpoint device to the deployment.

2. The method of claim 1, wherein the orchestrator also uses a proxy certificate to attempt to verify the integrity and the trustworthiness of the portion of the data, the proxy certificate delegating authority over the new endpoint device from an owner indicated by the ownership voucher to the orchestrator.

3. The method of claim 1, wherein the portion of the data comprises enablement data for the new endpoint device, the enablement data indicating characteristics of the new endpoint device that are expected of the new endpoint device.

4. The method of claim 3, wherein the enablement data comprises at least one selected from a list consisting of:
a device image for the new endpoint device;
a type of the new endpoint device; and
licensing information for the new endpoint device.

5. The method of claim 4, wherein the device image comprises:
a list of hardware components of the new endpoint device.

6. The method of claim 5, where performing the integrity verification process for the new endpoint device comprises:
obtaining, by the orchestrator, information regarding hardware components of the new endpoint device;
comparing, by the orchestrator, the information to the list of hardware components; and
in an instance of the comparing where the information substantially matches the list of the hardware components:
concluding that the integrity of the new endpoint device is successfully verified.

7. The method of claim 6, wherein the information substantially matches the list of the hardware components when matching criteria is met, the matching criteria indicating a minimum level of matching between the information and the list of the hardware components.

8. The method of claim 1, wherein the URL specifies a network endpoint, and the URL being a part of a certificate of the certificate chain.

9. The method of claim 8, wherein the network endpoint comprises reachability information for a network device maintained by a manufacturer of the new endpoint device or an intermediate owner of the new endpoint device.

10. The method of claim 1, wherein onboarding the new endpoint device comprises:
issuing, by the orchestrator, at least one work order for performance by the new endpoint device, the at least one work order being cryptographically verifiable by the new endpoint device using, at least, the certificate chain.

11. A non-transitory machine-readable medium having instructions stored therein, which when executed by a processor, cause the processor to perform operations for managing endpoint devices of a distributed system, the operations comprising:
identifying, by an orchestrator, a new endpoint device of the endpoint devices requesting to join a deployment managed by the orchestrator;
obtaining, by the orchestrator and using a uniform resource locator (URL) from an ownership voucher for the new endpoint device, a portion of data from a remote entity;
attempting, by the orchestrator and using at least a certificate chain from the ownership voucher, to verify integrity and trustworthiness of the portion of the data;
in a first instance of the attempting where the integrity and trustworthiness of the portion of the data is verified:
performing, by the orchestrator, an integrity verification process for the new endpoint device; and
in an instance of the performing where integrity of the new endpoint device is successfully verified:
onboarding, by the orchestrator and using the ownership voucher, the new endpoint device to the deployment.

12. The non-transitory machine-readable medium of claim 11, wherein the orchestrator also uses a proxy certificate to attempt to verify the integrity and the trustworthiness of the portion of the data, the proxy certificate delegating authority over the new endpoint device from an owner indicated by the ownership voucher to the orchestrator.

13. The non-transitory machine-readable medium of claim 11, wherein the portion of the data comprises enablement data for the new endpoint device, the enablement data indicating characteristics of the new endpoint device that are expected of the new endpoint device.

14. The non-transitory machine-readable medium of claim 13, wherein the enablement data comprises at least one selected from a list consisting of:
a device image for the new endpoint device;
a type of the new endpoint device; and
licensing information for the new endpoint device.

15. The non-transitory machine-readable medium of claim 14, wherein the device image comprises:
a list of hardware components of the new endpoint device.

16. A data processing system, comprising:
a processor; and
a memory coupled to the processor to store instructions, which when executed by the processor, cause the data processing system to perform operations for managing operation of endpoint devices of a distributed system, the operations comprising:
identifying, by an orchestrator, a new endpoint device of the endpoint devices requesting to join a deployment managed by the orchestrator;
obtaining, by the orchestrator and using a uniform resource locator (URL) from an ownership voucher for the new endpoint device, a portion of data from a remote entity;
attempting, by the orchestrator and using at least a certificate chain from the ownership voucher, to verify integrity and trustworthiness of the portion of the data;
in a first instance of the attempting where the integrity and trustworthiness of the portion of the data is verified:
performing, by the orchestrator, an integrity verification process for the new endpoint device; and
in an instance of the performing where integrity of the new endpoint device is successfully verified:
onboarding, by the orchestrator and using the ownership voucher, the new endpoint device to the deployment.

17. The data processing system of claim 16, wherein the orchestrator also uses a proxy certificate to attempt to verify the integrity and the trustworthiness of the portion of the data, the proxy certificate delegating authority over the new endpoint device from an owner indicated by the ownership voucher to the orchestrator.

18. The data processing system of claim 16, wherein the portion of the data comprises enablement data for the new endpoint device, the enablement data indicating characteristics of the new endpoint device that are expected of the new endpoint device.

19. The data processing system of claim 18, wherein the enablement data comprises at least one selected from a list consisting of:
a device image for the new endpoint device;
a type of the new endpoint device; and
licensing information for the new endpoint device.

20. The data processing system of claim 19, wherein the device image comprises:
a list of hardware components of the new endpoint device.
